(19) United States
(12) Patent Application Publication
(10) Pub. No.: US 2006/0051999 A1
(43) Pub. Date: Mar. 9, 2006

(54) Connector element with quick screw connection

(76) Inventors: Frederic Allemann, Courroux (CH); Norbert Schaffner, Bassecourt (CH)

Correspondence Address: Martin A. Farber, Suite 473, 866 United Nations Plaza, New York, NY, 10017, US

(21) Appl. No.: 11/146,407

(22) Filed: Jun. 6, 2005

(30) Foreign Application Priority Data
Jun. 4, 2004 (DE) 102004028060.6

(51) Int. Cl. H01R 13/62

(52) U.S. Cl. 439/320

(57) ABSTRACT

A connector element of an electrical plug-in connection with a contact carrier (1) has one or more electrical contacts, and a w screw sleeve (2) which is rotatably associated with the contact carrier (1). A radially protruding thread engagement projection (3) enters into a fastening thread (4) of a mating connector element (5). The thread engagement projection (3) is associated with the screw sleeve (2) in such a way that it can yield elastically in the radial direction such that, after sliding over the thread ribs (4′) of the fastening thread (4), it can be driven by a drive bevel (6, 10) of the connector element into the thread groove (4″).

The invention relates to a connector of an electrical plug-in connection with a contact carrier having one or more electrical contacts and with a screw sleeve which is rotatably associated with the contact carrier and has a radially protruding thread engagement projection for entering into a fastening thread of a mating connector element.

A connector element of the type mentioned at the beginning is described for example in DE 43 015 03 A1. This document describes a contact carrier having a number of contacts. A screw sleeve is rotatably associated with this contact carrier. The screw sleeve has a thread which can be screwed onto a mating thread of a mating connector element.

An electrical plug-in connector is also known from DE 101 21 675 A1. Provided there is a connector part having a threaded sleeve for screwing-on of a union nut of a screw connector part which can be screwed together with the connector part. The threaded sleeve has a projection behind which a snap-fit ring of a snap-fit connector part can engage.

The invention is based on the object of developing a screw/plug-in connection in a way which enhances its functional features.

The object is achieved by the invention specified in the claims. At the same time, each claim has in principle independent inventive significance. Claim 1 achieves the object on which the invention is based first and foremost by the thread engagement projection being associated with the screw sleeve in such a way that it can yield elastically in the radial direction such that, after sliding over the thread ribs of the fastening thread, it can be driven by a drive bevel of the connector element into the thread groove. Claim 2 achieves the object substantially by the screw sleeve forming an actuating element which can be displaced axially relative to the contact carrier and can be rotatably actuated, by the axial displacement of which the thread engagement projection, after sliding over the thread ribs of the fastening-over thread, can be driven into thread engagement and by the rotational displacement of which, with the thread projection entered into thread engagement, an axial force can be applied to the contact carrier in the direction of the mating connector element. As a result of this configuration, the connector element and the mating connector element can be plugged into one another. The screw sleeve can then be pushed over the thread ribs of the fastening thread. This dispenses with the need for the screw sleeve to be loosely screwed onto the fastening thread. Only in the end phase of the fastening does the screw thread act as a positive fastening means and force transmission means for the application of the axial force. This axial force is then of significance in particular whenever the connector connection is sealed by means of an elastic seal which is compressed in the end phase of the fastening. This allows the contact carrier to be pressed with its end face, and in particular with its end edge, against an O-ring, which produces a watertight connection between the contact carrier and the insertion opening into which the contact carrier can be inserted. The contacts between the two connector elements are then shielded in a watertight manner with respect to the outside world. In a development of the invention, it is provided that the thread engagement projection is formed by individual projections respectively of a spring tongue of the screw sleeve disposed on a helical line. The thread engagement projection can consequently be formed not by a continuous thread—as known in the prior art—but by individual projections which are separated from one another in the circumferential direction. It is nevertheless also provided that the individual projections respectively engage in a number of thread grooves. For this purpose, individual projections may also lie one behind the other in the axial direction. In order to divide the thread engagement projection into a number of individual projections lying separately from one another in the circumferential direction, it is proposed that spring tongues are separated from one another by axial cuts. The spring tongues may be associated with an actuating element. The actuating element is associated, in particular in a rotatable manner, with the contact carrier. It can, however, also be displaced in the axial direction relative to the contact carrier. The actuating element is preferably blocked against axial displacement in a first rotational position relative to the contact carrier and can only be displaced axially relative to the contact carrier after turning into a second rotational position. This produces the advantage that an insertion force can be exerted on the contact carrier by the actuating element without the actuating element being displaced axially with respect to the contact carrier. It is only after the contact carrier has been inserted into the corresponding mating connector element that the actuating element is to be turned in order that it can then be displaced axially. The actuating element is, in particular, connected in a rotationally fixed manner to the spring tongues. In the case of this configuration, the actuating element also serves as a screwing force transmission element to the thread engagement projection. The actuating element may take the form of a sleeve. It may have an annular inner projection, which slides on the outer wall of the contact carrier. This inner projection may have circumferentially offset recesses, with which projections of the contact carrier are associated. If the projections are aligned with the recesses, the actuating element can be displaced axially. Otherwise, as stated above, axial displacement is blocked. In a first variant of the invention, the spring tongues are integrally formed on the actuating element. In the case of this variant of the invention, the spring tongues are displaced along with the actuating element during the axial displacement of the latter. It is the axial displacement of the actuating element that drives the spring tongues in such a way that the thread engagement projection or the individual projections enter into the thread grooves associated with them. Serving for this purpose is a corresponding drive bevel, which may be associated with the spring tongue or with the actuating element. The actuating thread may be an internal thread. The drive bevel may then be formed by an insertion sleeve having an insertion cavity for the mating connector element. The actuating element may, however, also be associated in an axially displaceable manner with the spring tongues which are substantially non-displaceable relative to the contact carrier. In the case of this variant, rotational driving elements for the rotationally fixed but axially displaceable association of the actuating element formed as a sleeve with the spring tongues are provided. In the case of this variant, the spring tongues may be associated with a spring tongue carrier rotatably mounted on the contact carrier. A rotational driving web may serve for rotational co-drive of the spring tongue carrier. This axially running web is associated with the actuating element and may protrude into an axial cut separating the spring tongues from one another. In an alternative variant, the fastening thread is formed by an external thread. In this case, the drive bevel may be formed by the front end of the actuating element, which can be displaced over the spring tongue carrier. The spring tongue may also define a bevel. It is preferably formed as a radially protruding drive bead lying opposite the thread engagement projection.

In order to block the screw sleeve temporarily against axial displacement with respect to the contact carrier or the spring tongue, measures of other kinds may also be provided. A latching coupling between the spring tongue and the contact carrier is regarded as a preferred measure. In the axially retracted position, in which the thread engagement projections are not in engagement with the mating thread, there is a latching connection between the screw sleeve and the contact carrier or the spring tongue. A spring ring which is held in a circumferential latching groove of the spring tongue is regarded as a suitable latching means. The spring ring lies with a portion in a yielding groove of the screw sleeve. If the spring force with which the spring ring lies in the latching depression is overcome, the spring ring leaves the latching depression and can escape into the yielding annular groove. In this state, the screw sleeve can be displaced with respect to the spring tongues.

Exemplary embodiments of the invention are explained below on the basis of accompanying drawings, in which:

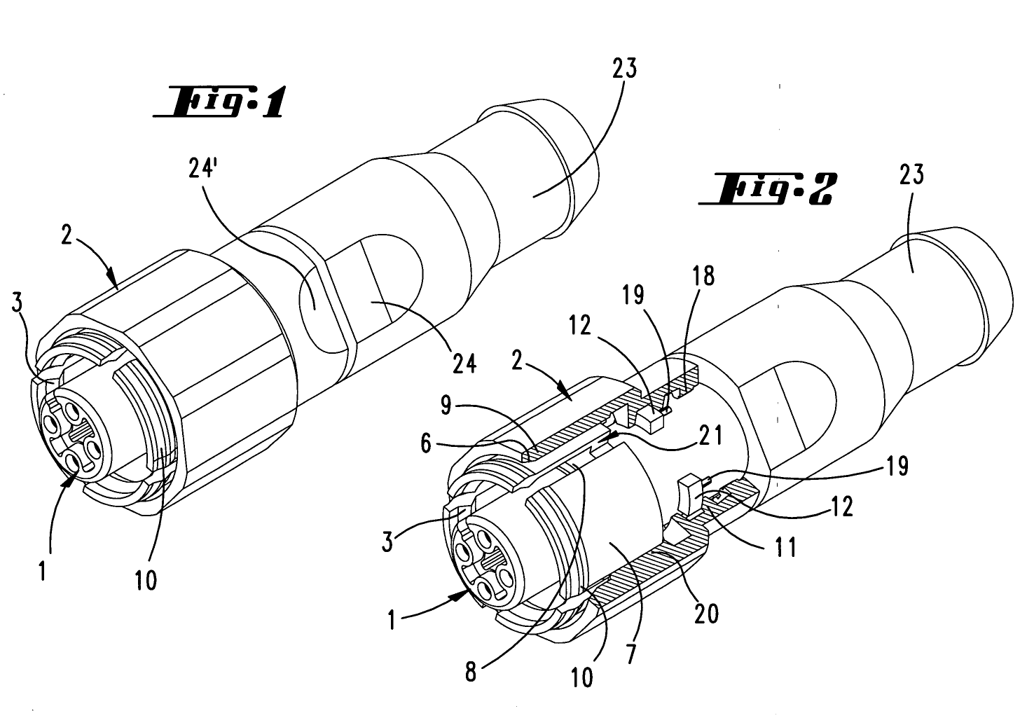

FIG. 1 shows a first exemplary embodiment of a connector element for plugging onto a mating connector element provided with an external thread,

FIG. 2 shows a representation according to FIG. 1 with an actuating element cut away in one quarter,

FIG. 3 shows an associated contact carrier in perspective representation,

FIG. 4 shows a spring tongue carrier, having 4 spring tongues, in perspective representation,

FIG. 5 shows an associated actuating element in perspective representation,

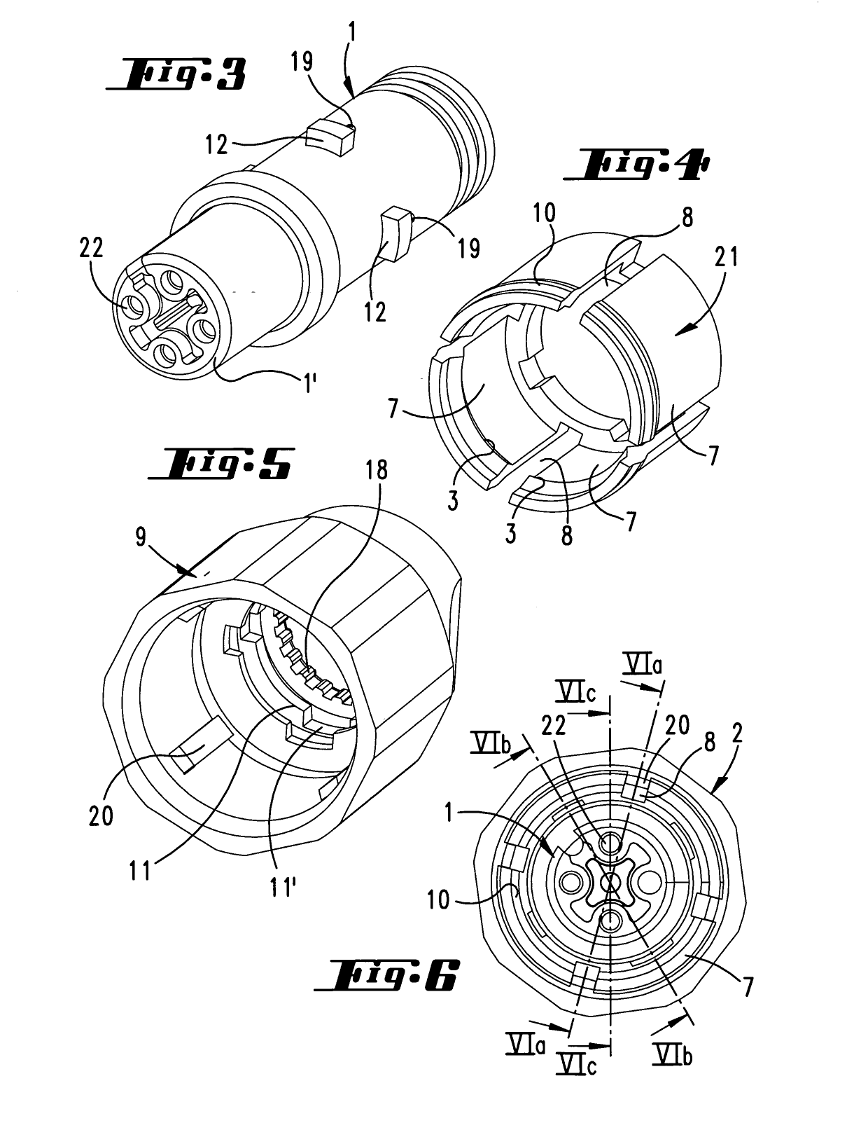

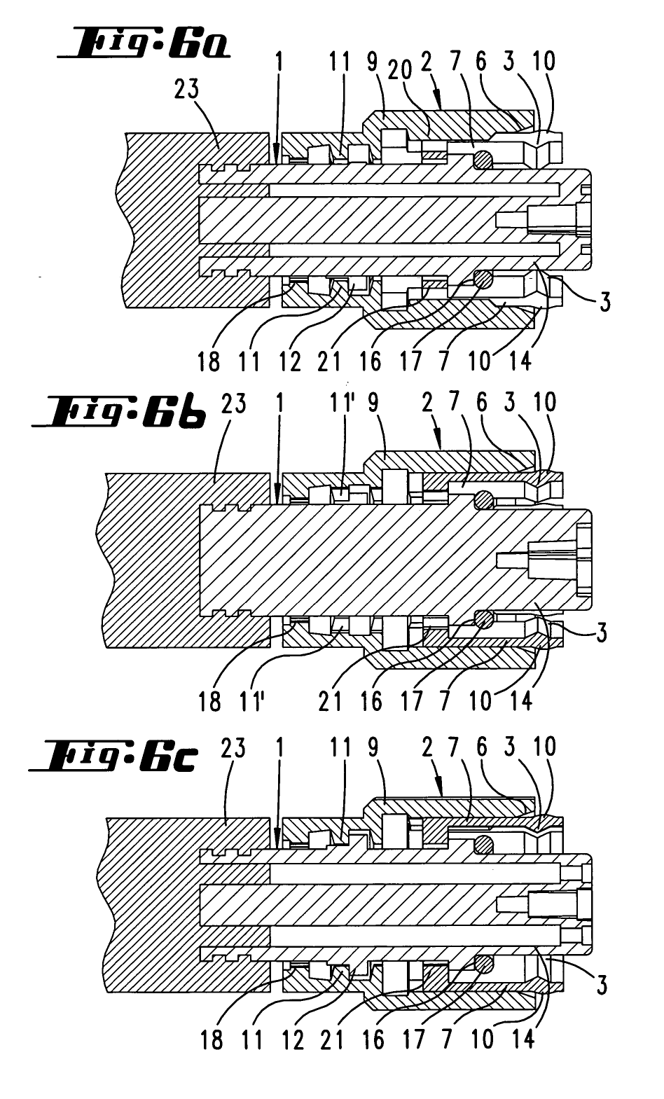

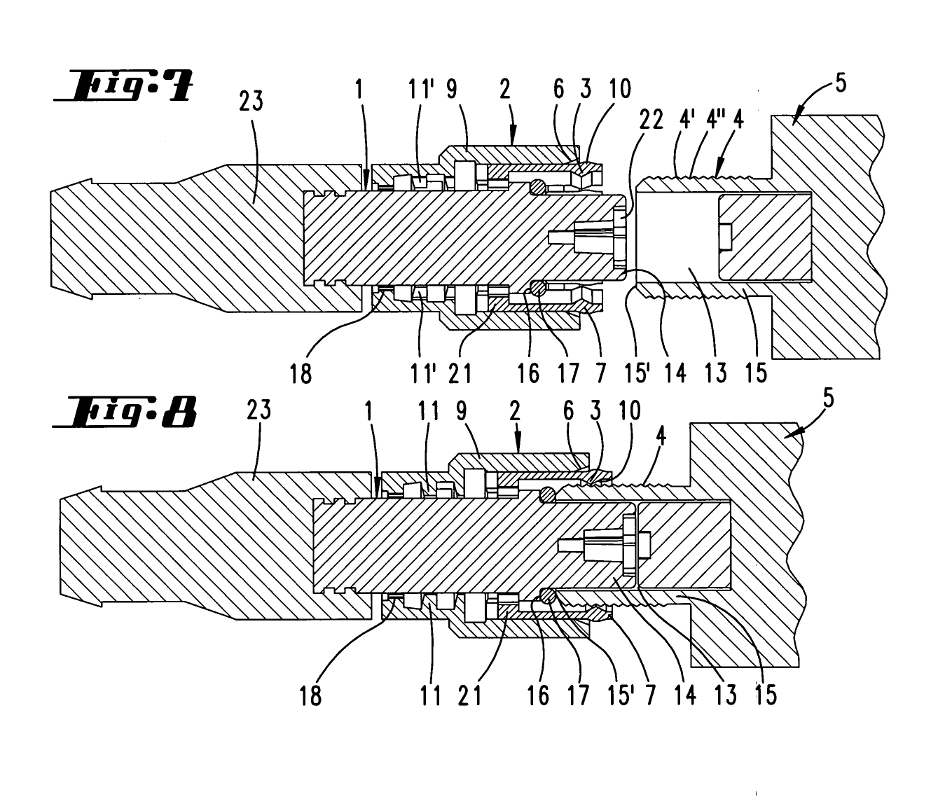

FIG. 6 shows an end view of the connector element,

FIG. 6a shows a section along the line VIa-VIa in FIG. 6,

FIG. 6b shows a section along the line VIb-VIb in FIG. 6,

FIG. 6c shows a section along the line VIc-VIc in FIG. 6,

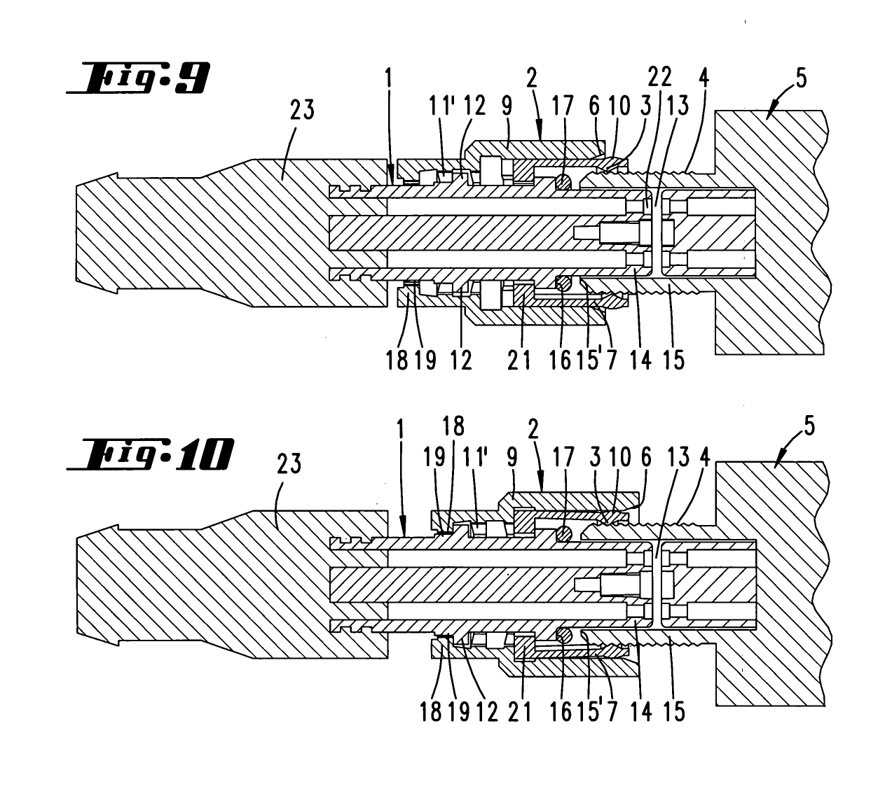

FIG. 7 shows a sectional representation approximately according to FIG. 6a before the insertion of the connector element into a mating connector element,

FIG. 8 shows a representation following on from FIG. 7, the connector elements having been inserted into the mating connector element,

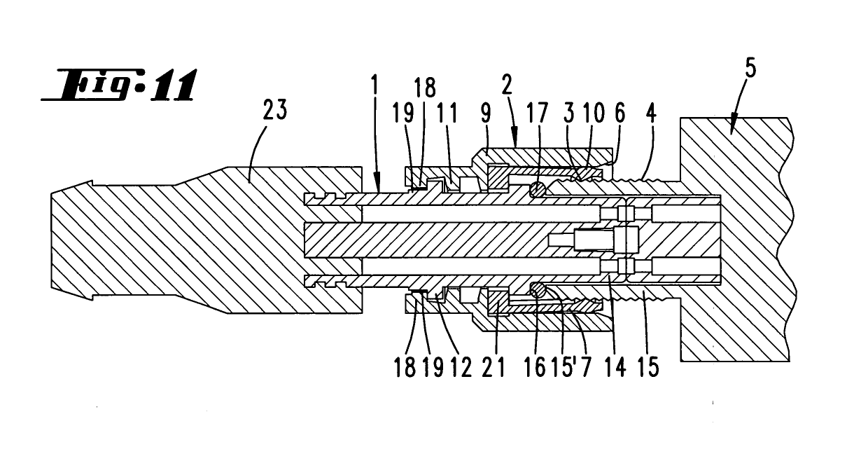

FIG. 9 shows a representation following on from FIG. 8 in which the actuating element has been turned to the extent that the recess 11′ is in line with the radial projection 12 and the actuating element can be displaced axially,

FIG. 10 shows a representation following on from FIG. 9 in which the actuating element has been displaced and the thread engagement projection has been driven into the mating thread,

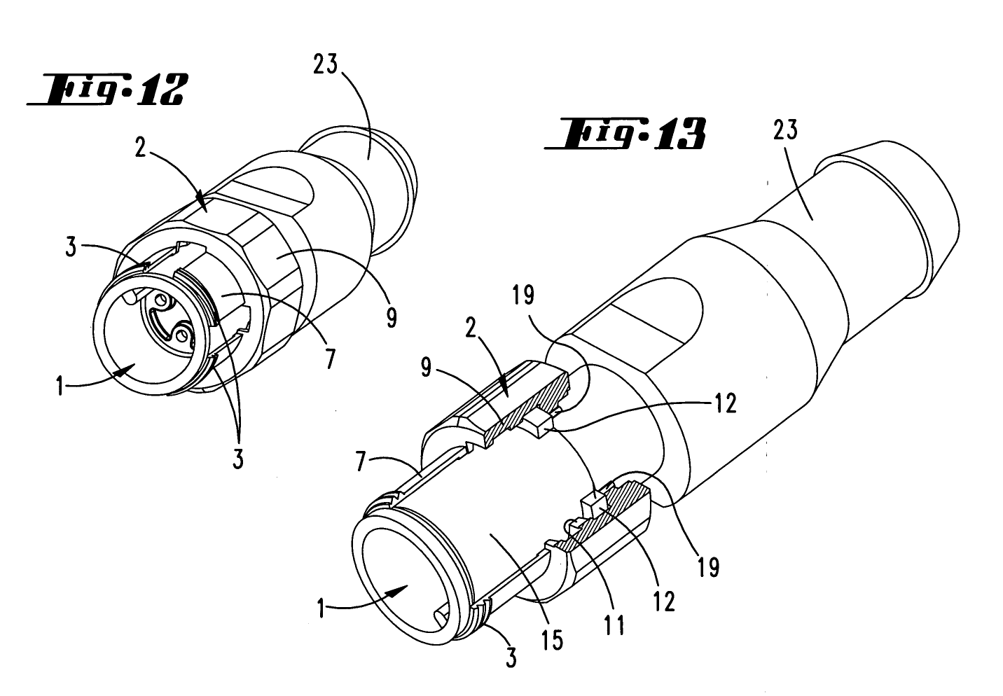

FIG. 11 shows a representation following on from FIG. 10, after screwing home the screw sleeve consisting of the actuating element and the spring tongue carrier,

FIG. 12 shows a second exemplary embodiment of the invention in a representation according to FIG. 1, in which exemplary embodiment the thread insertion projection is pointing radially outward, so that the connector element can be inserted into an internal thread of a mating connector element,

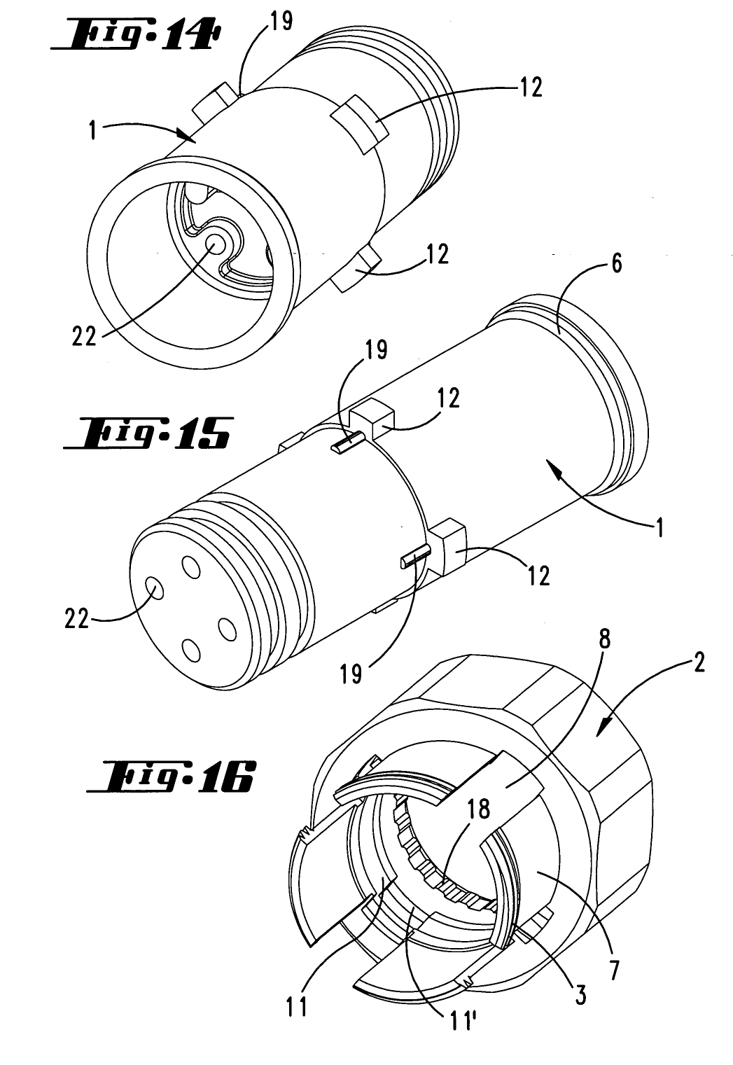

FIG. 13 shows a representation according to FIG. 12 in which a quarter has been cut away from the actuating element,

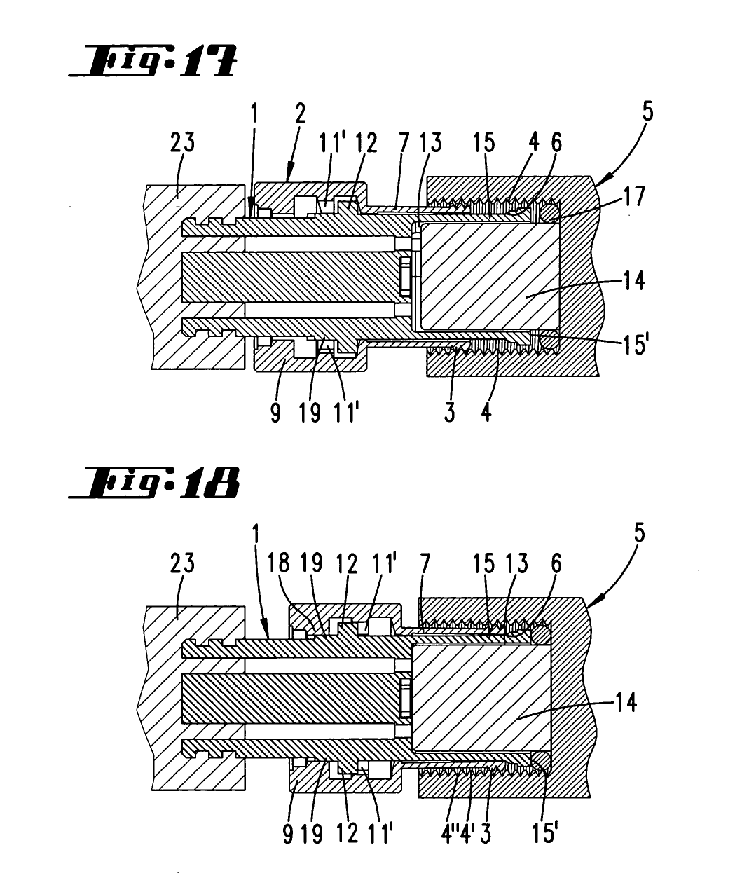

FIG. 14 shows a perspective view of the contact carrier of the second exemplary embodiment,

FIG. 15 shows a representation according to FIG. 14, but turned through approximately 180 degrees,

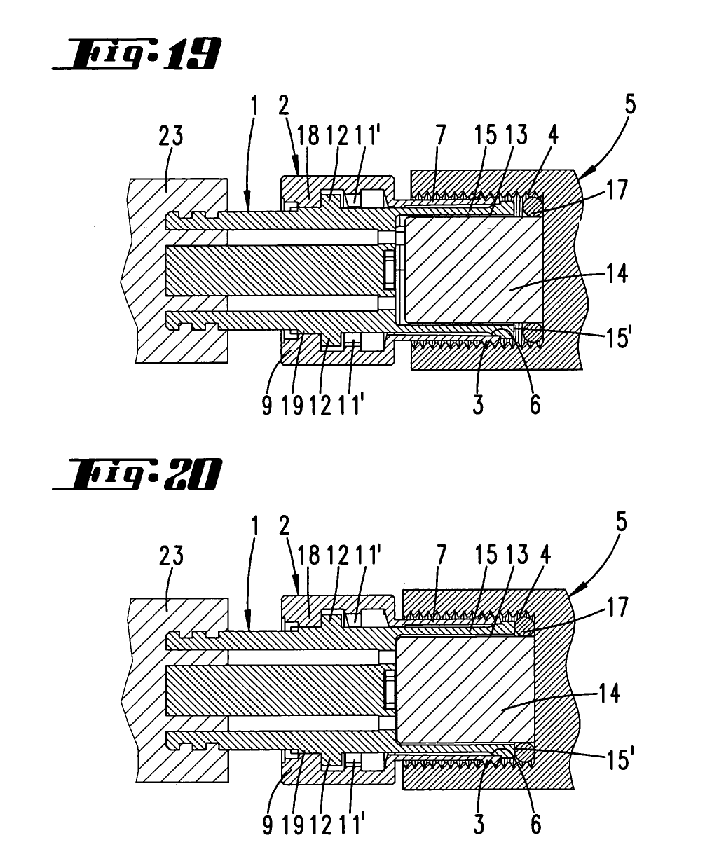

FIG. 16 shows a perspective representation of the screw sleeve,

FIG. 17 shows a representation of the second exemplary embodiment in longitudinal section, the contact carrier having been inserted into an insertion opening of a mating connector element,

FIG. 18 shows a representation following on from FIG. 17, the screw sleeve 2 having been displaced axially after slight rotation,

FIG. 19 shows a representation following on from FIG. 18 in which the front end of the spring tongues has run onto a drive bevel, so that the thread engagement projection has entered into the internal thread,

FIG. 20 shows a representation following on from FIG. 19 in which the end face of the contact carrier 1 has been pressed against a sealing ring by rotation of the screw sleeve 2,

FIG. 21 shows a third exemplary embodiment of the invention in a representation according to FIG. 2,

FIG. 22 shows the third exemplary embodiment of the invention in a representation according to FIG. 9,

FIG. 23 shows the third exemplary embodiment of the invention in a representation according to FIG. 10,

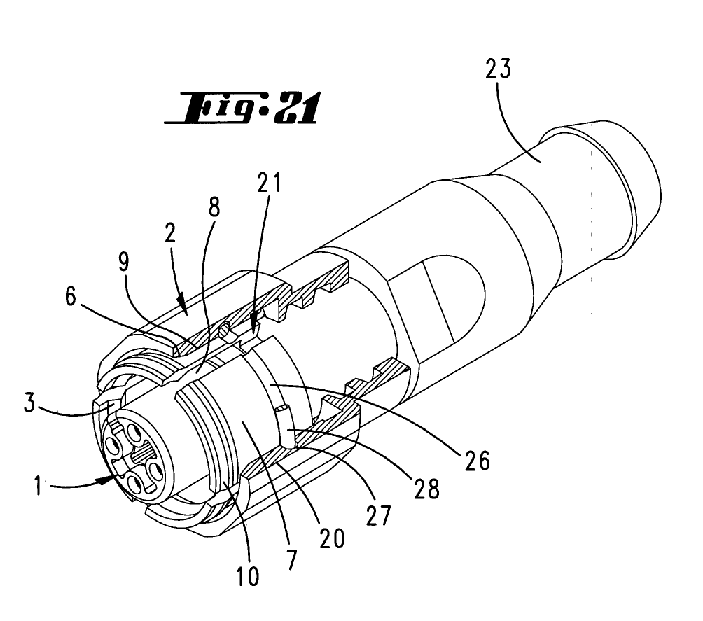

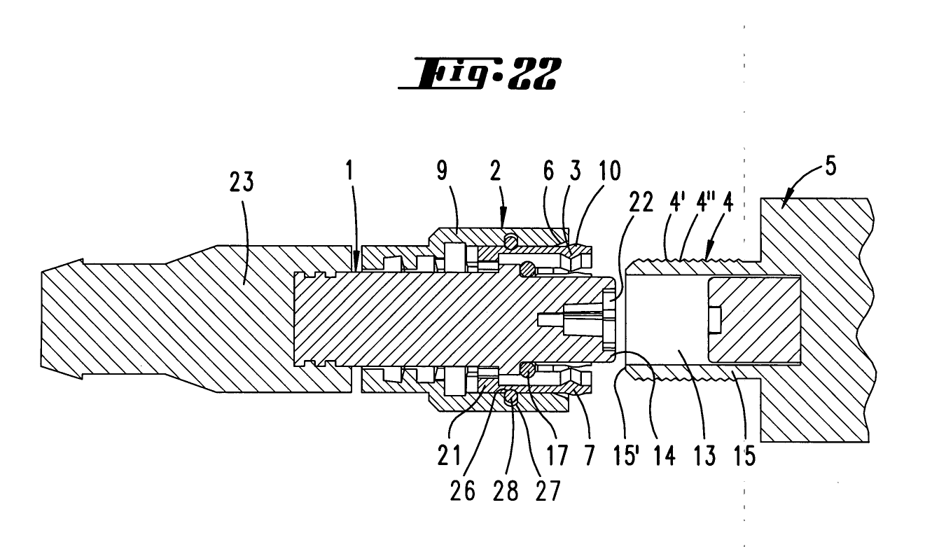

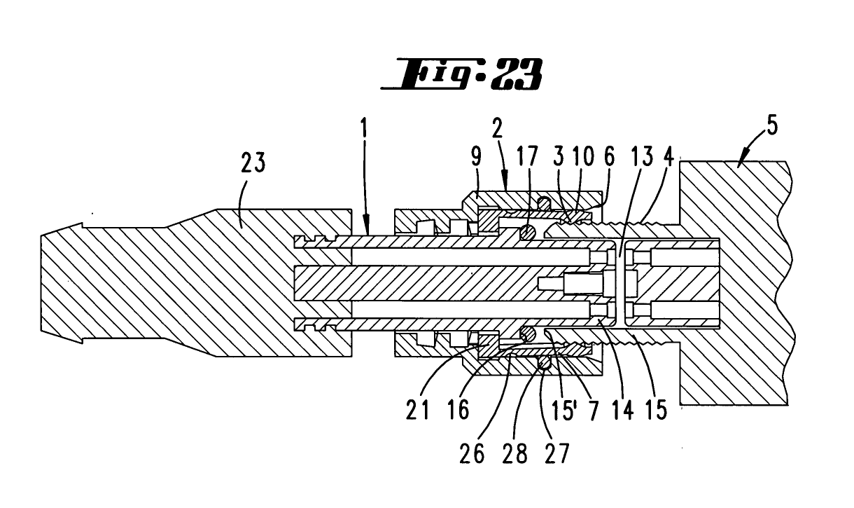

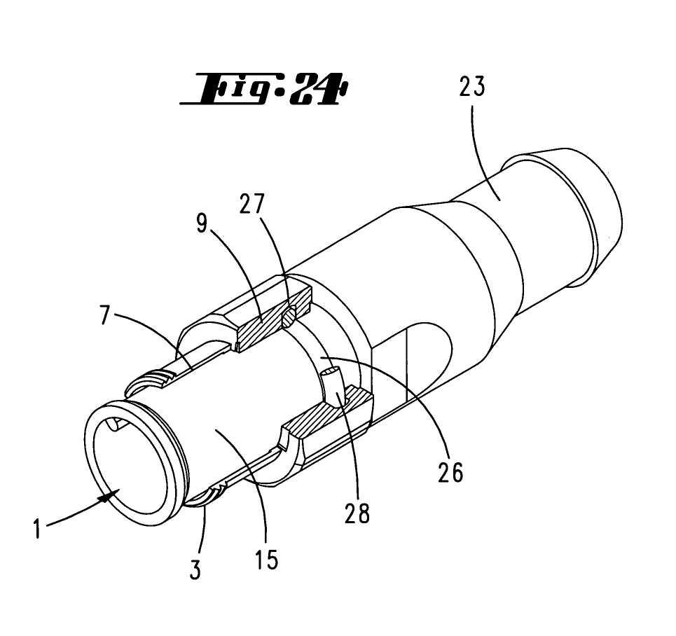

FIG. 24 shows a fourth exemplary embodiment of the invention in a representation according to FIG. 13,

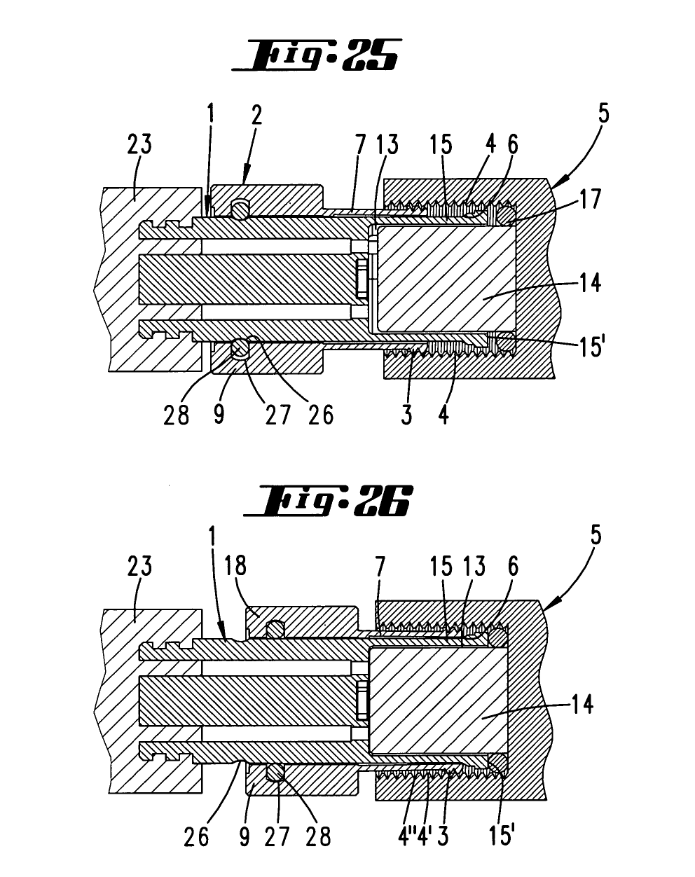

FIG. 25 shows the fourth exemplary embodiment of the invention in a representation according to FIG. 17, and

FIG. 26 shows the fourth exemplary embodiment of the invention in a representation according to FIG. 18.

The first exemplary embodiments, represented in FIGS. 1-11, concerns a connector which forms a contact carrier 1 which can be inserted into an insertion opening 13 of a mating connector element 5. At the rear, the contact carrier 1 is encapsulated by a cap 23. And inside the contact carrier 1 there are a number of electrical contacts, which are not represented in the drawings but only indicated as contact openings 22, which can be brought into electrically conductive connection with mating contacts of the mating connector element.

On the contact carrier 1 there is a spring tongue carrier 21, which is mounted on the contact carrier 1 to be rotatable but substantially non-displaceable axially. The spring tongue carrier 21 forms a number of spring tongues 7, four in the exemplary embodiment, extending in the axial direction and able to yield elastically in the radial direction. The spring tongue carrier 21 can be turned with the aid of an actuating element 9. For this purpose, the actuating element 9 has radially inwardly protruding rotational driving webs 20, which protrude into axial cuts 8 of the spring tongue carrier 21 extending between the spring tongues. These axial cuts 8 separate the spring tongues 7 from one another and are open at both ends in the axial direction.

The actuating element 9 is mounted on the contact carrier 1 in an axially displaceable manner. To be able to displace the actuating element 9 axially with respect to the spring tongue carrier 21, it must be turned out of a first rotational position, in which a radial projection 12 of the contact carrier 1 lies in front of an inner annular projection 11 of the actuating element 9, into a second rotational position, in which the radial projections 12 are in line with recesses 11′ of the inner annular projection 11.

At the rear of the inner annular projection 11, the actuating element 9 has an annular projection 18 with latching lugs. The annular projection 18 cooperates with latching projections 19 of the contact carrier 1 as a safeguard against vibration in such a way that, in its advanced position, the actuating element 9 can only be turned after overcoming a detent.

The front leading end of the actuating element 9 forms a drive bevel 6. This drive bevel 6 cooperates with a drive bead 10 of each spring tongue 7. The drive bead 10 is directed radially outward. Lying opposite it is a radially inwardly directed thread engagement projection 3. The thread engagement projection 3 is divided into a multiplicity of individual projections, which altogether lie on a helical line, the slope of which corresponds to the fastening thread 4 of the mating connector element 5. The axial extent of the thread engagement projection 3 is adapted to the pitch of the fastening thread 4 in such a way that the thread engagement projection 3 can enter into the thread groove 4″ lying between two thread ribs 49, in order to enter into a positive connection with the fastening thread 4 after a corresponding radially inwardly directed displacement. The radial inward displacement required for this is achieved by the drive bevel 6 sliding on the drive bead 10, for which purpose the actuating element 9 is pushed over the spring tongues 7 in the axial direction.

The actuating element 9 and the spring tongues 7 associated with the spring tongue carrier 21 together form a screw sleeve 2.

The way in which the first exemplary embodiment functions is as follows. In a starting position, represented in FIG. 7, in which the actuating element 9 assumes a withdrawn position, the two recessed grip portions 24, 24′ are in line with each other. In this position, the radial projection designated in FIG. 2 by the reference numeral 12 lies in front of the inner annular projection 11, so that the actuating element 9 cannot be displaced axially, but the drive bevel 6 is at a radial spacing from the drive bead 10, so that, when the socket 14 formed by the contact carrier 1 is inserted into an insertion opening 13 of the mating connector element 5, the thread engagement projection 3 slides over the ribs 4′ of the fastening threads 4. As is to be gathered from FIG. 7, the wall of the insertion cavity 13 is formed by the threaded portion 15.

Once the insertion position according to FIG. 8 has been reached, the actuating element is turned until the recess 11 is in line with the radial projection 12. Along with this turning of the actuating element 9, the spring tongues 7 are also turned. A slight axial displacement of the contact carrier 1 or the socket 14 relative to the insertion opening 13 allows the axial position of the connector element and the mating connector element to be set in such a way that the thread engagement projection 3 lies opposite with a fastening groove 4″. If, as shown in FIG. 10, the actuating element 9 is now advanced further, the drive bevel 6 slides over the drive beads 10, in order to displace the spring tongues 7 radially inward, the respective individual projections 3 engaging positively in the fastening thread groove 4″. The fact that, as represented to an exaggerated extent in the exemplary embodiment, a gap thereby forms between the front end of the socket 14 and the base of the insertion opening 13, or the front end 15′ has a spacing from the sealing ring 17 located at the shoulder 16, is acceptable, since the spring tongue carrier 21 is turned along with the actuating element 9 when the latter is subsequently turned. The thread engagement projection 3, thread engagement with the fastening thread 4, brings about the screw sleeve effect, as a result of which the position represented in FIG. 11 is reached after a corresponding angle of rotation, in which position the front end 15′ reaches sealing abutment with a sealing ring 17. In the rotational movement from FIG. 10 to FIG. 11, the detents of the annular projection 18 latch over the latching projections 19.

The second exemplary embodiment, represented in FIGS. 12-20, differs from the first exemplary embodiment substantially in that here the contact carrier 1 of the connector element forms the insertion cavity 13 and the mating connector element 5 forms the socket 14 to be received in this insertion cavity 13. Between the socket 14 and the internal thread 4 of the mating connector element 5 there is an annular gap, into which an insertion sleeve 15, which is formed here by the contact carrier 1, can be inserted.

A further difference from the first exemplary embodiment is formed by the screw sleeve 2. In this exemplary embodiment, it is formed in one piece. In the exemplary embodiment, four spring tongues 7 are formed on the sleeve-shaped actuating element 9. Here, too, each spring tongue has a thread engagement projection 3 at the inner end. In the case of the exemplary embodiment, however, the thread engagement projection 3 protrudes radially outward and has two or more projections lying one behind the other, to be able to enter into a number of thread grooves simultaneously.

It is also the case in this exemplary embodiment that the actuating element 9 has an inner annular projection 11 with associated recesses 11′, corresponding to which are radial projections 12 of the contact carrier 1. In an insertion position, here, too, recessed grip portions 24, 241 are in line with one another, so that each of the 4 radial projections 12 lies in front of an inner annular portion 11, so that the screw sleeve 2 can be turned but cannot be displaced axially. In this position, which corresponds to a withdrawn position, the ends of the spring tongues 7 carrying thread engagement projections 3 are at an axial spacing from a circumferentially extending drive bevel 6 of the front end 15′ of the insertion sleeve 15.

If in this operating position, the connector element is associated with the mating connector element 5, as shown in FIG. 17, the insertion sleeve 15 passes over the socket 14, so that the socket 14 enters into the insertion cavity 13 of the contact carrier 1. Electrical contacts (not represented) come here into a electrically conductive connection with one another.

After the complete or virtually complete insertion of the insertion sleeve 15 into the corresponding annular space of the mating connector element 5, the actuating element 9 is turned until the recess 11′ is in line with the radial projection 12. The actuating element can then be displaced axially. The spring tongues 7 thereby enter deeper into the annular space of the mating connector element 5, until they butt against the drive bevel 6. An axial displacement possibly required here between the connector part and the mating connector part makes it possible to find the axial position, which is represented in FIG. 19, in which the thread engagement projections 3 disposed on a helical line enter into the thread grooves 4″. The front ends of the spring tongues 7 thereby slide on the annular drive bevel 6.

Starting from this fully advanced position of the actuating element, a rotational actuation of the actuating element 9 then takes place, in which not only the latching lugs of the annular projection 18 latch over the latching projections 19 in the course of securing against vibration, but also the contact carrier 1 is displaced in the axial direction toward the mating connector element 5, until the end face 15′ butts against the sealing ring 17 located at the base of the annular space.

The exemplary embodiments are concerned with a quick screw connection. The screw sleeve 2 can be pushed by axial displacement into or over the corresponding mating thread, a thread engagement projection 3 sliding over the thread ribs 4′ of the fastening thread. In the end phase, the thread engagement projection 3 finds its positive engagement in the fastening thread 4 as a result of a radially controlled movement. Now the screw sleeve 2 displays the known screw sleeve effect, that is of realizing axial solidity between the two connector elements by rotational actuation.

In the case of the further exemplary embodiments, represented in FIGS. 21-26, the screw sleeve 2 need not be turned into a specific rotational position to allow it to be displaced axially with respect to the spring tongues. In the case of these exemplary embodiments, the screw sleeve 2 is held in the withdrawn position by a detent 26, 27, 28.

In the case of the exemplary embodiment represented in FIGS. 21-23, the spring tongues 7 have a latching groove 26 extending in the circumferential direction on the outer wall of the spring tongues 7. In this latching groove 26, which has a rounded base, there lies a spring ring 28. It lies there with a radially inwardly directed stress. In the withdrawn position of the screw sleeve that is represented in FIG. 21, a further portion of the spring ring 28 lies in a yielding groove 27 of the screw sleeve 2. The yielding groove 27 in this case extends on the inner wall of the screw sleeve 2 in the circumferential extent of the latter.

If the connector element is inserted into the mating connector element 5 from the position represented in FIG. 22, the contact carrier 1 being guided into the insertion cavity 13, the detent 26, 27, 28 holds the screw sleeve 2 in its retracted position until for instance the position represented in FIG. 8 is reached. In this position, the front end 15′ butts against the sealing ring 17 and consequently exerts a resistance against the axial force. Now the detent can be overcome by increasing the axial force on the screw sleeve 2. The spring ring 28 thereby leaves the latching groove 26 and lies virtually completely in the yielding groove 27. It is then possible by axial displacement to reach the position represented in FIG. 23, in which the front end 15′ is spaced slightly from the sealing ring 17 after finding a thread engagement position. If the screw sleeve 2 is now turned in the arresting direction, the thread engagement projections 3, which lie in the thread groove, are turned along with it until the connector element is firmly connected to the mating connector element in the way described above.

It is also the case in the exemplary embodiment represented in FIGS. 24-26 that the screw sleeve 2 is arrested in a latching position by means of a spring ring 28 lying in a latching groove 26. Here, the latching groove 26 is likewise associated with the contact carrier 1 as a circumferential groove. Here, too, the inner wall of the screw sleeve 2 has a yielding groove 27, in which the greatest cross-sectional area of the spring ring 28 lies.

The detent can only be overcome when the connector element is inserted so deep into the cavity of the mating connector element 5 that the front end 15′ butts against the sealing ring 17. The detent is overcome by increasing the axial force on the screw sleeve 2. The screw sleeve 2 can then be displaced in the axial direction with respect to the contact carrier 1, in order to reach the position represented in FIG. 26, in which the drive bevel 6 comes into effect, in order to drive the thread engagement projections 3 into the threads of the internal thread. The two elements are then firmly screwed to one another by turning the screw sleeve 2.

All disclosed features are (in themselves) pertinent to the invention. The disclosure content of the associated/attached priority documents (copy of the prior patent application) is also hereby incorporated in full in the disclosure of the application, including for the purpose of incorporating features of these documents in claims of the present application.

1-18. (canceled)

19. Connector element of an electrical plug-in connection comprising: a contact carrier (1) having one or more electrical contacts and a screw sleeve (2) which is rotatably associated with the contact carrier (1); a radially protruding thread engagement projection (3) for entering into a fastening thread (4) of a mating connector element (s); wherein the thread engagement projection (3) is associated with the screw sleeve (2) so as to yield elastically in the radial direction such that that, after sliding over thread ribs (4′) of the fastening thread (4), the thread engagement projection can be driven by a drive bevel (6, 10) of the connector element into the thread groove (4″):

20. Connector element of an electrical plug-in connection comprising: a contact carrier (1) having one or more electrical contacts and a screw sleeve (2) which is rotatably associated with the contact carrier (1); a radially protruding thread engagement projection (3) for entering into a fastening thread (4) of a mating connector element (5); wherein the screw sleeve (2) forms an actuating element (9) which can be displaced axially relative to the contact carrier (1) and is rotatable, by axial displacement of which the thread engagement projection (3), after sliding over the thread ribs (4′) of the fastening thread (4), can be driven into thread engagement and by rotational displacement of which, with the thread engagement projection (3) entered into thread engagement, an axial force can be applied to the contact carrier (1) in the direction of the mating connector element (5).

21. Connector element according to claim 19, wherein the thread engagement projection (3) is formed by individual projections respectively of a spring tongue (7) of the screw sleeve (2) disposed on a helical line.

22. Connector element according to claim 21, wherein the individual projections (3) respectively engage in a number of thread grooves (4″).

23. Connector element according to claim 21, wherein the spring tongues (7) are separated from one another by axial cuts (8).

24. Connector element according to claim 21, wherein an actuating element (9) is associated with the spring tongues (7).

25. Connector element according to claim 24, wherein the actuating element (9) is blocked against axial displacement in a first rotational position or detent position relative to the contact carrier (1), and can only be displaced axially after turning or overcoming a detent into a thread engagement rotational position.

26. Connector element according to claim 24, wherein the actuating element (9) is connected in a rotationally fixed manner to the spring tongues (7).

27. Connector element according to claim 24, further comprising an inner annular projection (11) of the sleeve-shaped actuating element (9), having recesses (11′), and wherein projections (12) of the contact carrier (1) are associated with the recesses (11′).

28. Connector element according to claim 24, wherein the spring tongues (7) are integrally formed on the actuating element (9).

29. Connector element according to claim 19, wherein the fastening thread (4) is an internal thread, and the drive bevel (6) is formed by an insertion sleeve (15) having an insertion cavity (13) for the mating connector element (5).

30. Connector element according to claim 21, wherein an actuating element 19) is associated in an axially displaceable manner with the spring tongues (7) which are substantially non-displaceable relative to the contact carrier (1).

31. Connector element according to claim 27, further comprising rotational driving elements for a rotationally fixed but axially displaceable association of the actuating element (9) formed as a sleeve with the spring tongues (7).

32. Connector element according to claim 21, wherein the spring tongues (7) are associated with a spring tongue carrier (21) rotatably mounted on the contact carrier (1).

33. Connector element according to claim 32, wherein for rotational co-drive of the spring tongue carrier (21) a rotational driving web (20) of the actuating element (9) protrudes into an axial cut (8).

34. Connector element according to claim 32, wherein the fastening thread (4) is an external thread and a drive bevel (6) is formed by the front end (9′) of an actuating element (9), which can be displaced over the spring tongue carrier (21).

35. Connector element according to claim 19, further comprising a radially protruding drive bead (10) lying opposite the thread engagement projection (3).

36. Connector element according to claim 21, further comprising a detent holding the screw sleeve (2) in an axially retracted position, the detent being formed by a spring ring (28), which in its latched position lies in a latching groove (26) of a spring tongue (7) and, when the detent is overcome, can enter into a yielding groove (27) of the screw sleeve (2).
